(19) United States
(12) Patent Application Publication
(10) Pub. No.: US 2012/0001880 A1
(43) Pub. Date: Jan. 5, 2012

(54) DISPLAY DEVICE

(76) Inventors: Christopher Brown, Oxford (GB); Kohei Tanaka, Osaka (JP)

(21) Appl. No.: 13/148,610

(22) PCT Filed: Oct. 22, 2009
(86) PCT No.: PCT/JP2009/068188

§ 371 Date: Aug. 9, 2011

(30) Foreign Application Priority Data
Feb. 10, 2009 (JP) 2009-028863

(51) Int. Cl. G09G 5/00

(52) U.S. Cl. 345/207

(57) ABSTRACT

A display device includes a photosensor in a pixel region (1) of an active matrix substrate (100). The display device includes a light shielding film (LS) provided on the side of a photodiode (D1) that is opposite to the light receiving face thereof, and an electrode (CTL) provided opposing the light shielding film (LS) so as to form a capacitor (C_{SER}) in series with parasitic capacitance (C_{c} and Cₐ) between the light shielding film (LS) and the photodiode (D1). A signal for reducing a voltage drop in a storage node (INT) that accompanies a change in the potential of a reset signal is applied to the electrode (CTL) when a sensing period starts.

### TECHNICAL FIELD

The present invention relates to a display device with a photosensor that has a photodetection element such as a photodiode or a phototransistor, and in particular relates to a display device including a photosensor in a pixel region.

### BACKGROUND ART

Conventionally, there has been proposed a display device with a photosensor that includes a photodetection element such as a photodiode inside a pixel to detect the brightness of external light and pick up an image of an object that is located close to the display. Such a display device with a photosensor is envisioned to be used as a bidirectional communication display device or display device with a touch panel function.

In a conventional display device with a photosensor, when using a semiconductor process to form known constituent elements such as signal lines, scan lines, Thin Film Transistors (TFTs), and pixel electrodes on an active matrix substrate, photodiodes or the like are formed at the same time on the active matrix substrate (see Document 1).

FIG. 19 shows an example of a conventional photosensor (Documents 2 and 3) formed on an active matrix substrate. The conventional photosensor shown in FIG. 19 is configured by a photodiode D1, a capacitor C2, and a thin-film transistor M2. The anode of the photodiode D1 is connected to wiring RST, which is for supplying a reset signal. The cathode of the photodiode D1 is connected to one of the electrodes of the capacitor C2 and the gate of the thin-film transistor M2. The drain of the thin-film transistor M2 is connected to wiring VDD, and the source thereof is connected to wiring OUT. The other electrode of the capacitor C2 is connected to wiring RWS, which is for supplying a readout signal.

In this configuration, the reset signal and the readout signal are respectively supplied to the wiring RST and the wiring RWS at predetermined times, thus enabling obtaining sensor output V_{PIX} that is in accordance with the amount of light received by the photodiode D1. A description will now be given of operations of the conventional photosensor shown in FIG. 19, with reference to FIG. 20. Note that the reset signal at low level (e.g., −4 V) is shown as V_{RST.L}, the reset signal at high level (e.g., 0 V) is shown as V_{RST.H}, the readout signal at low level (e.g., 0 V) is shown as V_{RWS.L}, and the readout signal at high level (e.g., 8 V) is shown as V_{RWS.H}.

First, when the high level reset signal V_{RST.H} is supplied to the wiring RST, the photodiode D1 becomes forward biased, and the potential V_{INT} of the gate of the thin-film transistor M2 is expressed by Expression (1) below.

V_{INT}=V_{RST.H}−V_{F} (1)

In Expression (1), V_{F} is the forward voltage of the photodiode D1. Since V_{INT} is lower than the threshold voltage of the thin-film transistor M2 at this time, the thin-film transistor M2 is in a non-conducting state in the reset period.

Next, the reset signal returns to the low level V_{RST.L} (time t=RST in FIG. 20), and thus the photocurrent integration period (sensing period indicated by T_{INT} shown in FIG. 20) begins. In the integration period, a photocurrent that is proportionate to the amount of incident light received by the photodiode D1 flows out of the capacitor C2 to discharge the capacitor C2. Accordingly, the potential V_{INT} of the gate of the thin-film transistor M2 when the integration period ends is expressed by Expression (2) below.

V_{INT}=V_{RST.H}−V_{F}−ΔV_{RST}·C_{PD}/C_{T}−I_{PHOTO}·T_{INT}/C_{T} (2)

In Expression (2), ΔV_{RST} is the pulse height of the reset signal (V_{RST.H}−V_{RST.L}), and C_{PD} is the capacitance of the photodiode D1. C_{T} is the sum of the capacitance of the capacitor C2, the capacitance C_{PD} of the photodiode D1, and a capacitance C_{TFT} of the thin-film transistor M2. I_{PHOTO} is the photocurrent of the photodiode D1, and T_{INT} is the length of the integration period. In the integration period as well, V_{INT} is lower than the threshold voltage of the thin-film transistor M2, and therefore the thin-film transistor M2 is in the non-conducting state.

When the integration period ends, the readout signal rises at a time t=RWS shown in FIG. 20, and thus the readout period begins. Note that the readout period continues while the readout signal is at the high level. At this point, the injection of charge into the capacitor C2 occurs. As a result, the potential V_{INT} of the gate of the thin-film transistor M2 is expressed by Expression (3) below.

V_{INT}=V_{RST.H}−V_{F}−ΔV_{RST}·C_{PD}/C_{T}−I_{PHOTO}·T_{INT}/C_{T}+ΔV_{RWS}·C_{INT}/C_{T} (3)

ΔV_{RWS} is the pulse height of the readout signal (V_{RWS.H}−V_{RWS.L}). Accordingly, since the potential V_{INT} of the gate of the thin-film transistor M2 becomes higher than the threshold voltage, the thin-film transistor M2 enters the conducting state and functions as a source follower amplifier along with a bias thin-film transistor M3 provided at the end of the wiring OUT in each column. In other words, the sensor output voltage V_{PIX} from the thin-film transistor M2 is proportionate to the integral value of the photocurrent of the photodiode D1 in the integration period.

Note that in FIG. 20, the broken line waveform indicates changes in the potential V_{INT} in the case where a small amount of light is incident on the photodiode D1, and the solid line waveform indicates changes in the potential V_{INT} in the case where external light is incident on the photodiode D1. In FIG. 20, ΔV is a potential difference proportionate to the amount of light that has been incident on the photodiode D1.

### CITATION LIST

### Patent Documents

Document 1: JP 2006-3857A
Document 2: WO 2007/145346
Document 3: WO 2007/145347

### DISCLOSURE OF INVENTION

### Problem to be Solved by the Invention

In a display device including a photosensor in a pixel such as that described above, in order to prevent light from the backlight from being incident on the photodetection element of the photosensor in the pixel, a light shielding layer LS is generally provided on the back side (backlight side) of the photodetection element (diode D1 in FIG. 21), as shown in FIG. 21 for example. However, since the light shielding layer LS is generally formed by a metal thin film, a parasitic capacitance is formed between the light shielding layer LS and the diode D1. For example, in the configuration shown in FIG. 21, a parasitic capacitance C_{c} is formed on the cathode side of the diode D1, and a parasitic capacitance Cₐ is formed on the anode side. Due to such parasitic capacitance, as shown in FIG. 22, the potential V_{INT} of the storage node drops at the moment when the reset signal returns from the high level V_{RST.H} to the low level V_{RST.L} (the beginning of the integration period T_{INT} shown in FIG. 22). This phenomenon is hereinafter referred to as “reset feed-through”.

In FIG. 22, the voltage drop due to reset feed-through is indicated by V_{FT}. There is the problem that when the voltage drop V_{FT} due to reset feed-through occurs at the beginning of the integration period in this way, the dynamic range of the photosensor becomes narrower.

In light of the above-described problems, an object of the present invention is to provide a display device having a photosensor with a wide dynamic range by reducing the voltage drop occurring due to feed-through attributed to the parasitic capacitance between the photodetection element and the light shielding layer.

### Means for Solving the Problem

In order to solve the above-described problems, a display device according to the present invention is a display device including a photosensor in a pixel region of an active matrix substrate, the photosensor including: a photodetection element that receives incident light; a storage node that is connected to the photodetection element, the potential of the storage node changing in accordance with an output current from the photodetection element; reset signal wiring that supplies a reset signal to the photosensor; readout signal wiring that supplies a readout signal to the photosensor; a sensor switching element for reading out the potential of the storage node to output wiring as sensor circuit output, the potential of the storage node having changed in accordance with the amount of light received by the photodetection element in a sensing period, the sensing period being from when the reset signal is supplied until when the readout signal is supplied; a light shielding film provided on a side of the photodetection element that is opposite to a light receiving face thereof, and an electrode provided opposing the light shielding film so as to form a capacitor in series with a parasitic capacitance between the light shielding film and the photodetection element, wherein a signal for reducing a voltage drop in the storage node that accompanies a change in the potential of the reset signal is applied to the electrode when the sensing period starts.

### Effects of the Invention

According to the present invention, an electrode is provided so as to form a capacitor in series with the parasitic capacitance between the light shielding film and the photodetection element, and a signal for reducing a voltage drop in the storage node that accompanies a change in the potential of the reset signal is applied to the electrode when the sensing period starts, thus enabling reducing a voltage drop occurring due to feed-through attributed to the parasitic capacitance between the photodetection element and the light shielding layer. This enables providing a display device having a photosensor with a wide dynamic range.

### BRIEF DESCRIPTION OF DRAWINGS

FIG. 1 is a block diagram showing a schematic configuration of a display device according to an embodiment of the present invention.

FIG. 2 is an equivalent circuit diagram showing a configuration of a pixel in a display device according to Embodiment 1 of the present invention.

FIG. 3 is a plan view showing an example of a planar structure of the photosensor according to Embodiment 1.

FIG. 4 is a schematic diagram showing electrical connection relationships between members in a cross-section taken along line A-B shown in FIG. 3.

FIG. 5 is an equivalent circuit diagram of the photosensor according to Embodiment 1 of the present invention.

FIG. 6 is an equivalent circuit diagram of the photosensor according to Embodiment 1 of the present invention.

FIG. 7 is a timing chart showing an example of various types of signals supplied to the photosensor of Embodiment 1 and changes in the potential of a storage node.

FIG. 8 is a timing chart showing sensing timing in the display device according to Embodiment 1.

FIG. 9 is a circuit diagram showing an internal configuration of a sensor pixel readout circuit.

FIG. 10 is a waveform diagram showing a relationship between a readout signal, sensor output, and output of the sensor pixel readout circuit.

FIG. 11 is an equivalent circuit diagram showing a schematic configuration of a sensor column amplifier.

FIG. 12 is a timing chart showing an example of various types of signals supplied to the photosensor of Embodiment 1 and changes in the potential of the storage node.

FIG. 13 is a timing chart showing an example of various types of signals supplied to the photosensor of Embodiment 1 and changes in the potential of the storage node.

FIG. 14 is a plan view showing an example of a planar structure of a photosensor according to Embodiment 2.

FIG. 15 is a schematic diagram showing electrical connection relationships between members in a cross-section taken along line A-B shown in FIG. 14.

FIG. 16 is a plan view showing an example of a planar structure of a photosensor according to Embodiment 3.

FIG. 17 is a schematic diagram showing electrical connection relationships between members in a cross-section taken along line A-B shown in FIG. 16.

FIG. 18 is an equivalent circuit diagram of the photosensor according to Embodiment 3.

FIG. 19 is an equivalent circuit diagram showing an example of a conventional photosensor formed on an active matrix substrate.

FIG. 20 is a timing chart showing waveforms of driving signals in the conventional photosensor.

FIG. 21 is an equivalent circuit diagram of a conventional photosensor.

FIG. 22 is a waveform diagram showing an effect of reset feed-through in the conventional photosensor.

### DESCRIPTION OF THE INVENTION

A display device according to an embodiment of the present invention is a display device including a photosensor in a pixel region of an active matrix substrate, the photosensor including: a photodetection element that receives incident light; a storage node that is connected to the photodetection element, the potential of the storage node changing in accordance with an output current from the photodetection element; reset signal wiring that supplies a reset signal to the photosensor; readout signal wiring that supplies a readout signal to the photosensor; a sensor switching element for reading out the potential of the storage node to output wiring as sensor circuit output, the potential of the storage node having changed in accordance with the amount of light received by the photodetection element in a sensing period, the sensing period being from when the reset signal is supplied until when the readout signal is supplied; a light shielding film provided on a side of the photodetection element that is opposite to a light receiving face thereof; and an electrode provided opposing the light shielding film so as to form a capacitor in series with a parasitic capacitance between the light shielding film and the photodetection element, wherein a signal for reducing a voltage drop in the storage node that accompanies a change in the potential of the reset signal is applied to the electrode when the sensing period starts.

According to this configuration, an electrode is provided so as to form a capacitor in series with the parasitic capacitance between the light shielding film and the photodetection element, and a signal for reducing a voltage drop in the storage node that accompanies a change in the potential of the reset signal is applied to the electrode when the sensing period starts. This enables reducing the voltage drop occurring due to feed-through attributed to the parasitic capacitance between the photodetection element and the light shielding layer. As a result, it is possible to provide a display device having a photosensor with a wide dynamic range.

In the above display device, it is preferable that the electrode is metal wiring provided in parallel with the reset signal wiring and the readout signal wiring (first configuration). Also, it is furthermore preferable that the electrode is formed by the same material as the reset signal wiring and the readout signal wiring and in the same process. This enables simplifying the manufacturing process.

In the first configuration, it is furthermore preferable that the signal applied to the electrode is the same as the readout signal. In this case, in the readout period, the same pulse as the readout signal causes an upthrust in the voltage of the storage node via the series capacitor and the electrode, thus enabling efficiently reading out the sensor signal.

In the first configuration, it is furthermore preferable that the signal applied to the electrode is a signal that counteracts the voltage drop in the storage node that accompanies a change in the potential of the reset signal. This enables substantially completely eliminating the voltage drop occurring due to feed-through attributed to the parasitic capacitance between the photodetection element and the light shielding layer, thus making it possible to further widen the dynamic range.

It is preferable that the display device has a configuration further including a shield electrode that covers the photosensor, and the electrode is electrically connected to the shield electrode (second configuration). The shield electrode is an electrode for protecting the photosensor from interference from external circuitry, and can be formed by a transparent metal film made up of ITO, for example, or the like. In this way, connecting the shield electrode and the electrode for forming a capacitor in series with the parasitic capacitance between the light shielding film and the photodetection element enables using a signal applied to the shield electrode to suppress the voltage drop due to feed-through.

Note that in the second configuration, the signal applied to the electrode (i.e., the signal supplied to the shield electrode as well) may be a constant potential signal, or may be a signal that counteracts the voltage drop in the storage node that accompanies a change in the potential of the reset signal.

Also, it is preferable that the display device has a configuration in which the electrode is a portion of the readout signal wiring (third configuration). According to this configuration, a pulse that is the same as the readout signal is applied to the electrode for forming a capacitor in series with the parasitic capacitance between the light shielding film and the photodetection element, and therefore the voltage of the storage node is caused to upthrust not only via the readout wiring, but also via the electrode and the series capacitor in the readout period. This enables efficiently reading out the sensor signal.

Below is a description of more specific embodiments of the present invention with reference to the drawings. Note that although the following embodiments show examples of configurations in which a display device according to the present invention is implemented as a liquid crystal display device, the display device according to the present invention is not limited to a liquid crystal display device, and is applicable to any display device that uses an active matrix substrate. It should also be noted that due to having a photosensor, the display device according to the present invention is envisioned to be used as, for example, a display device with a touch panel that performs input operations after detecting an object that is close to the screen, or a bidirectional communication display device that is equipped with a display function and an image capture function.

Also, for the sake of convenience in the description, the drawings that are referred to below show simplifications of, among the constituent members of the embodiments of the present invention, only relevant members that are necessary for describing the present invention. Accordingly, the display device according to the present invention may include any constituent members that are not shown in the drawings that are referred to in this specification. Also, regarding the dimensions of the members in the drawings, the dimensions of the actual constituent members, the ratios of the dimensions of the members, and the like are not shown faithfully.

### Embodiment 1

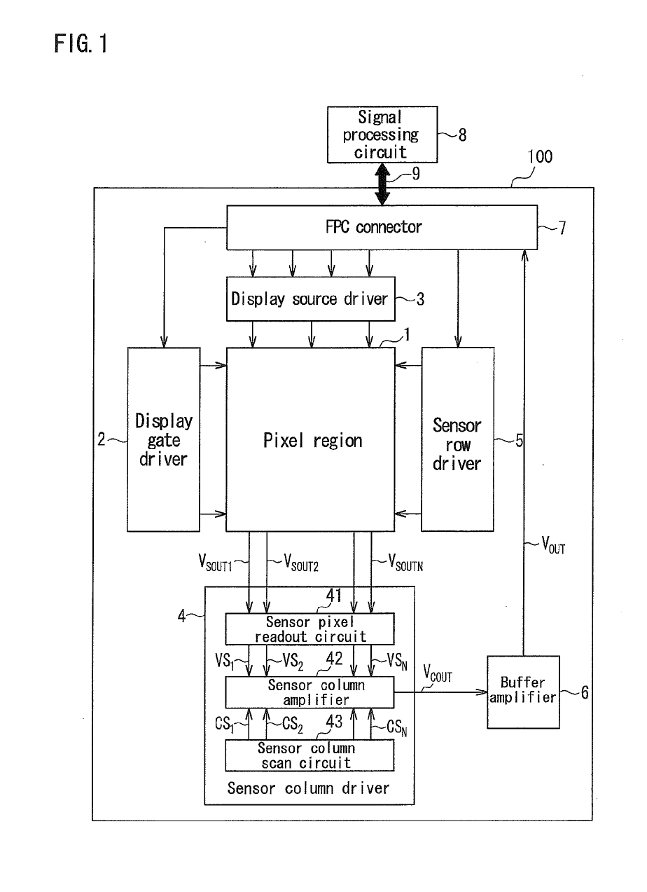

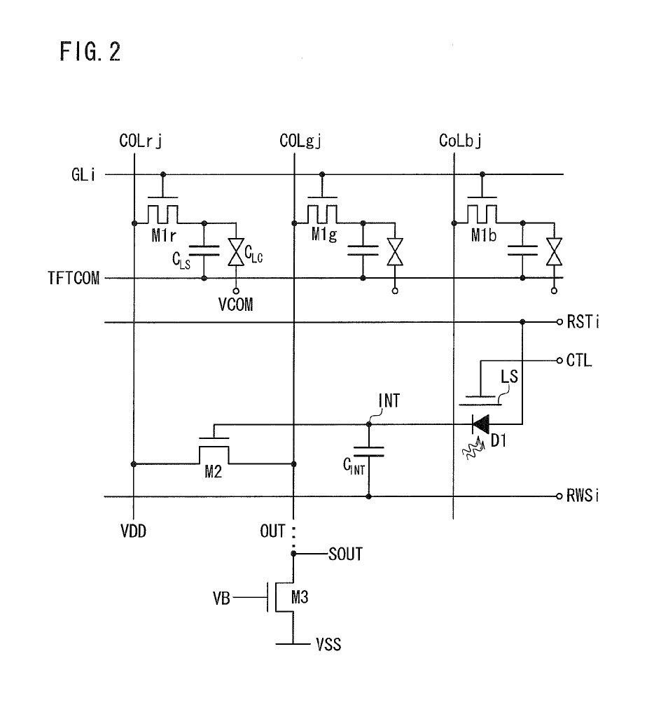

First is a description of a configuration of an active matrix substrate included in a liquid crystal display device according to Embodiment 1 of the present invention with reference to FIGS. 1 and 2.

FIG. 1 is a block diagram showing a schematic configuration of an active matrix substrate 100 included in the liquid crystal display device according to an embodiment of the present invention. As shown in FIG. 1, the active matrix substrate 100 includes at least a pixel region 1, a display gate driver 2, a display source driver 3, a sensor column driver 4, a sensor row driver 5, a buffer amplifier 6, and an FPC connector 7 on a glass substrate. Also, a signal processing circuit 8 for processing image signals picked up by a photodetection element (described later) in the pixel region 1 is connected to the active matrix substrate 100 via the FPC connector 7 and an FPC 9.

Note that the above constituent members on the active matrix substrate 100 can also be formed monolithically on the glass substrate by a semiconductor process. Alternatively, a configuration is possible in which the amplifier and various drivers among the above constituent members are mounted on the glass substrate by Chip On Glass (COG) technology or the like. As another alternative, it is possible for at least some of the above constituent members shown on the active matrix substrate 100 in FIG. 1 to be mounted on the FPC 9. The active matrix substrate 100 is attached to a common substrate (not shown) that has a common electrode formed on the entire face thereof, and a liquid crystal material is enclosed in the gap therebetween.

The pixel region 1 is a region in which a plurality of pixels are formed in order to display an image. In the present embodiment, a photosensor for picking up an image is provided in each pixel in the pixel region 1. FIG. 2 is an equivalent circuit diagram showing the disposition of a pixel and a photosensor in the pixel region 1 of the active matrix substrate 100. In the example in FIG. 2, each pixel is formed by three colors of picture elements, namely R (red), G (green), and B (blue), and one photosensor is provided in each of the pixels composed of these three picture elements. The pixel region 1 has pixels disposed in a matrix having M rows×N columns, and photosensors that are likewise disposed in a matrix having M rows×N columns. Note that as described above, the number of picture elements is M×3N.

For this reason, as shown in FIG. 2, the pixel region 1 has, as wiring for the pixels, gate lines GL and source lines COL that are disposed in a matrix. The gate lines GL are connected to the display gate driver 2. The source lines COL are connected to the display source driver 3. Note that the gate lines GL are provided in M rows in the pixel region 1. Hereinafter, the notation GLi (i=1 to M) is used when there is a need to distinguish between individual gate lines GL in the description. Meanwhile, three source lines COL are provided in each pixel in order to respectively supply image data to the three picture elements in each pixel as described above. The notations COLrj, COLgj, and COLbj (j=1 to N) are used when there is a need to distinguish between individual source lines COL in the description.

Thin-film transistors (TFTs) M1 are provided as switching elements for the pixels at intersections between the gate lines GL and the source lines COL. Note that in FIG. 2, the thin-film transistors M1 provided in the red, green, and blue picture elements are designated by M1r, M1g, and M1b, respectively. In each thin-film transistor M1, the gate electrode is connected to one of the gate lines GL, the source electrode is connected to one of the source lines COL, and the drain electrode is connected to a pixel electrode, which is not shown. Accordingly, as shown in FIG. 2, a liquid crystal capacitor C_{LC} is formed between the drain electrode of each thin-film transistor M1 and the common electrode (VCOM). Also, an auxiliary capacitor C_{LS} is formed between each drain electrode and a TFTCOM.

In FIG. 2, the picture element driven by the thin-film transistor M1r, which is connected to the intersection between one gate line GLi and one source line COLrj, is provided with a red color filter corresponding to that picture element, and red image data is supplied from the display source driver 3 to that picture element via the source line COLrj, and thus that picture element functions as a red picture element. Also, the picture element driven by the thin-film transistor M1g, which is connected to the intersection between the gate line GLi and the source line COLgj, is provided with a green color filter corresponding to that picture element, and green image data is supplied from the display source driver 3 to that picture element via the source line COLgj, and thus that picture element functions as a green picture element. Furthermore, the picture element driven by the thin-film transistor M1b, which is connected to the intersection between the gate line GLi and the source line COLbj, is provided with a blue color filter corresponding to that picture element, and blue image data is supplied from the display source driver 3 to that picture element via the source line COLbj, and thus that picture element functions as a blue picture element.

Note that in the example in FIG. 2, the photosensors are provided in the ratio of one per pixel (three picture elements) in the pixel region 1. However, the disposition ratio of the pixels and photosensors is arbitrary and not limited to this example, only. For example, one photosensor may be disposed per picture element, and a configuration is possible in which one photosensor is disposed for a plurality of pixels.

As shown in FIG. 2, the photosensor is composed of a photodiode D1 serving as a photodetection element, a capacitor C1, and a thin-film transistor M2. In the example in FIG. 2, the source line COLr also serves as wiring VDD, which is for supplying a constant voltage VDD from the sensor column driver 4 to the photosensor. Also, the source line COLg also serves as wiring OUT for sensor output.

The anode of the photodiode D1 is connected to wiring RST, which is for supplying a reset signal. The cathode of the photodiode D1 is connected to one of the electrodes of the capacitor C1 and the gate of the thin-film transistor M2. The drain of the thin-film transistor M2 is connected to the wiring VDD, and the source thereof is connected to the wiring OUT. In FIG. 2, the connection point (storage node) between the cathode of the photodiode D1, the one electrode of the capacitor C1, and the gate of the thin-film transistor M2 is designated by INT. The other electrode of the capacitor C1 is connected to wiring RWS, which is for supplying a readout signal. The lines RST and RWS are connected to the sensor row driver 5. Since the lines RST and RWS are provided in each row, the notations RSTi and RWSi (i=1 to M) are used hereinafter when there is a need to distinguish between the lines.

The sensor row driver 5 successively selects each group of lines RSTi and RWSi shown in FIG. 2 at a predetermined time interval t_{row}. Accordingly, each photosensor row in the pixel region 1 from which a signal charge is to be read out is successively selected.

Note that as shown in FIG. 2, the end of the wiring OUT is connected to the drain of a thin-film transistor M3, which is an insulated gate field effect transistor. Also, the drain of this thin-film transistor M3 is connected to output wiring SOUT, and a potential V_{SOUT} of the drain of the thin-film transistor M3 is output to the sensor column driver 4 as an output signal from the photosensor. The source of the thin-film transistor M3 is connected to the wiring VSS. The gate of the thin-film transistor M3 is connected to a reference voltage power supply (not shown) via reference voltage wiring VB.

In order to prevent light from the backlight from being incident on the photodiode D1, the photosensor of the present embodiment includes a light shielding film LS on the back side (backlight side) of the photodiode D1. The light shielding film LS is a metal thin film having light shielding characteristics, and is in a state of being electrically floating with respect to its surroundings. An electrode CTL is also provided opposing the light shielding film LS. In the photosensor of the present embodiment, as will be described below, applying a voltage to the electrode CTL enables reducing the voltage drop V_{FT} that occurs due to reset feed-through.

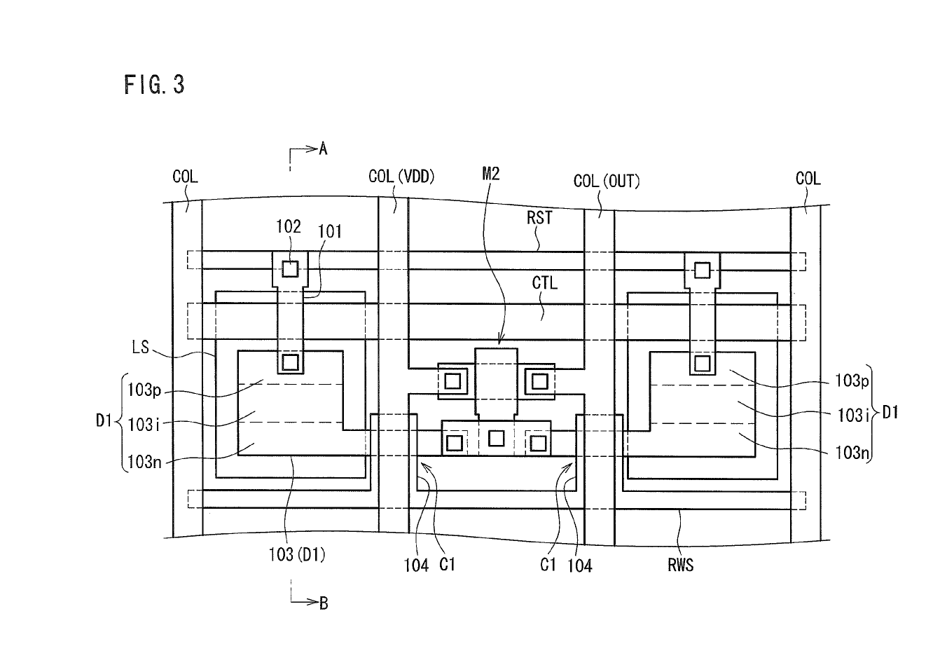

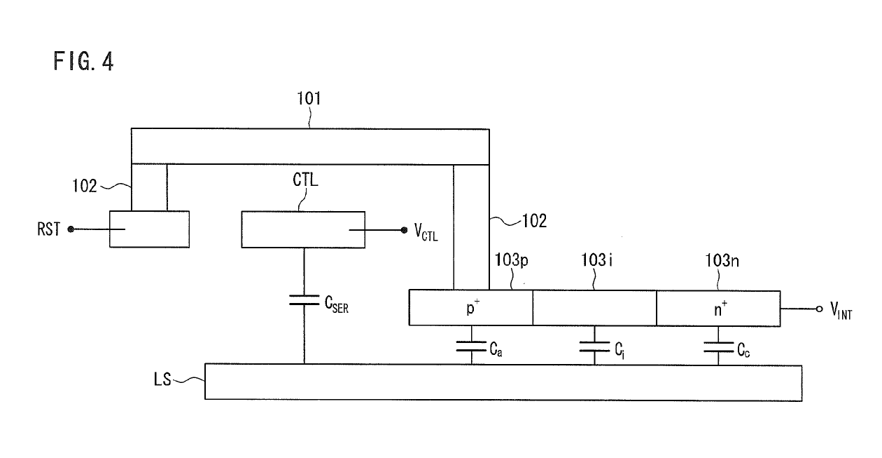

The following describes an example of the structure of the photosensor according to the present embodiment with reference to FIGS. 3 and 4. FIG. 3 is a plan view showing an example of the planar structure of the photosensor according to the present embodiment. FIG. 4 is a schematic diagram showing electrical connection relationships between members in a cross-section taken along line A-B shown in FIG. 3.

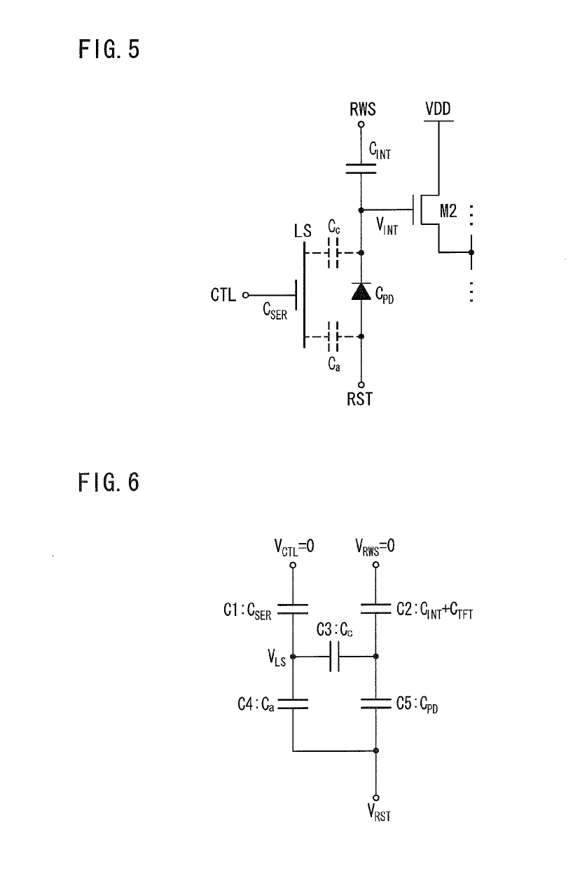

In the photosensor of the present embodiment, the lines RST and RWS and the electrode CTL are formed using the same material as the gate metal of the thin-film transistor M2, at the same time as the formation of the gate metal. As shown in FIG. 4, the electrode CTL is disposed in parallel with the lines RST and RWS. The electrode CTL is also in a state of being insulated from its surroundings and electrically floating. As shown in FIG. 5, a capacitor C_{SER} is formed in a portion where the electrode CTL opposes the light shielding film LS.

In the example shown in FIG. 4, the diode D1 is a PIN diode formed in a silicon film 103. An n-type semiconductor region (n layer) 103n, an intrinsic semiconductor region (i layer) 103i, and a p-type semiconductor region (p layer) 103p are provided along the planar direction of the silicon film 103 in the stated order. The silicon film 103 is formed on the top layer of an insulating film (not shown) that covers the light shielding film LS, and is electrically insulated from the light shielding film LS. The i layer 103i of the silicon film 103 serves as a photodetection region. Note that the i layer 103i needs only be a region that is nearly electrically neutral in comparison with the adjacent n layer 103n and p layer 103p. Preferably, the i layer 103i is a region that includes no impurities whatsoever, or a region whose conduction electron density and hole density are equal. Note that the i layer 103i may be an n-region whose n-type impurity diffusive concentration is lower than that of the n layer 103n, or a p-region whose p-type impurity diffusive concentration is lower than that of the p layer 103p.

In the present embodiment, there is no particular limitation on the type of silicon constituting the silicon film 103. However, in consideration of charge transfer rate, preferably the silicon film 103 is formed of continuous grain silicon or low-temperature polysilicon. Also, it is preferable that the silicon film 103 is formed using the process for forming the thin-film transistor M2.

As shown in FIG. 3, the capacitor C1 is formed between the silicon film 103 extending outside the diode D1 and an extension portion 104 of the wiring RWS. Also, as shown in FIG. 4, a parasitic capacitance Cₐ exists between the light shielding film LS and the anode (n layer 103n) of the photodiode D1, a parasitic capacitance Cᵢ exists between the light shielding film LS and the i layer 103i, and a parasitic capacitance Cₚ exists between the light shielding film LS and the cathode (p layer 103p).

Note that although the thin-film transistor M2 is provided in the region between the source lines COLg (VDD) and COLb (OUT), and one capacitor C1/diode D1 pair is provided on both sides of the thin-film transistor M2 in FIG. 3, a configuration is possible in which only one capacitor C1/diode D1 pair is provided.

As shown in FIG. 4, the wiring RST and the anode (p layer 103p) of the diode D1 are electrically connected by metal wiring 101, which is made up of the same material as the source metal, and a contact 102.

FIGS. 5 and 6 show an equivalent circuit diagram of the photosensor of the present embodiment. As shown in FIGS. 5 and 6, letting C_{c} be the parasitic capacitance between the light shielding film LS and the cathode of the photodiode D1, Cₐ be the parasitic capacitance between the light shielding film LS and the anode of the photodiode D1, C_{SER} be the capacitance between the light shielding film LS and the electrode CTL, C_{PD} be the self-parasitic capacitance of the photodiode D1, and C_{TFT} be the parasitic capacitance between the storage node INT and the thin-film transistor M2, the voltage drop V_{FT} due to reset feed-through is expressed by Expression (4) below. Note that in Expression (4), C_{FT} is the capacitance of the elements related to reset feed-through, C_{TOTAL} indicates the overall capacitance of the sensor circuit, and ΔRST indicates the amount of change (height) of the reset pulse.

$$\begin{matrix}[ Math 1 ] & \\ \begin{matrix}Δ {V}_{FT} = \frac{{C}_{FT}}{{C}_{TOTAL}} \cdot Δ {V}_{RST} \\ = \frac{( {C}_{5} + \frac{{C}_{3} \cdot {C}_{4}}{{C}_{1} + {C}_{3} + {C}_{4}} )}{( {C}_{2} + {C}_{5} + \frac{{C}_{3} ( {C}_{1} + {C}_{4} )}{{C}_{1} + {C}_{3} + {C}_{4}} )} \cdot Δ {V}_{RST} \\ = \frac{( {C}_{PD} + \frac{{C}_{a} \cdot {C}_{c}}{{C}_{a} + {C}_{c} + {C}_{SER}} )}{( {C}_{INT} + {C}_{IFT} + {C}_{PD} + \frac{{C}_{c} ( {C}_{SER} + {C}_{a} )}{{C}_{a} + {C}_{c} + {C}_{SER}} )} \cdot Δ {V}_{RST}\end{matrix} & ( 4 )\end{matrix}$$

Note that given that C_{SER}=0 in the above Expression (4), the voltage drop V_{FT} due to reset feed-through is expressed by Expression (5) below. In other words, the voltage drop V_{FT} expressed by Expression (5) indicates the influence of reset feed-through in the conventional configuration that does not include the electrode CTL.

$$\begin{matrix}[ Math 2 ] & \\ \begin{matrix}Δ {V}_{FT} = \frac{{C}_{FT}}{{C}_{TOTAL}} \cdot Δ {V}_{RST} \\ = \frac{( {C}_{PD} + \frac{{C}_{a} \cdot {C}_{c}}{{C}_{a} + {C}_{c}} )}{( {C}_{INT} + {C}_{TFT} + {C}_{PD} + \frac{{C}_{a} \cdot {C}_{c}}{{C}_{a} + {C}_{c}} )} \cdot Δ {V}_{RST}\end{matrix} & ( 5 )\end{matrix}$$

Here, it can be seen in a comparison of the numerator in the above Expression (4) and the numerator in Expression (5) that the numerator in Expression (4) is smaller. Also, it can be seen in a comparison of the denominator in Expression (4) and the denominator in Expression (5) that the denominator in Expression (4) is larger. Accordingly, the voltage drop V_{FT} indicated in Expression (4) is smaller than the voltage drop V_{FT} indicated in Expression (5). In view of this, in the photosensor of the present embodiment, a voltage is applied to the electrode CTL to form the capacitor C_{SER} serving as a series capacitor, thus producing an effect of reducing the value of the voltage drop V_{FT} occurring due to reset feed-through in comparison with the conventional configuration not including the capacitor C_{SER} serving as a series capacitor. This enables obtaining a wider dynamic range than that in conventional technology.

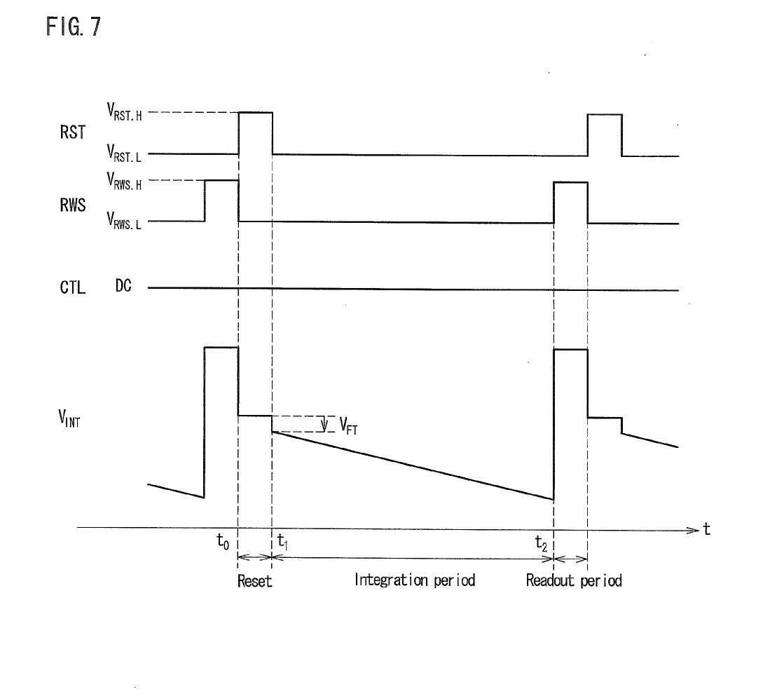

The following describes the reading out of sensor output from the pixel region 1 with reference to FIG. 7. FIG. 7 is a timing chart showing various types of signals supplied to the photosensor and changes in the potential of the storage node. In the example shown in FIG. 7, a constant voltage is applied to the electrode CTL.

First, when the reset signal supplied from the sensor row driver 5 to the wiring RST rises from the low level (V_{RST.L}) to the high level (V_{RST.H}) (time to in FIG. 7), the photodiode D1 becomes forward biased, and the potential V_{INT} of the connection point INT is expressed by Expression (6) below.

V_{INT}=V_{RST.H}−V_{F} (6)

In Expression (6), V_{F} is the forward voltage of the photodiode D1, ΔV_{RST} is the pulse height of the reset signal (V_{RST.H}−V_{RST.L}), and C_{PD} is the capacitance of the photodiode D1. C_{TOTAL} is the overall capacitance of the photosensor circuit, that is to say, the total capacitance of the connection point INT, which is the sum of the capacitance C_{INT} of the capacitor C1, the capacitance C_{PD} of the photodiode D1, and the capacitance C_{TFT} of the thin-film transistor M2. Since V_{INT} is lower than the threshold voltage of the thin-film transistor M2 at this time, the thin-film transistor M2 is in a non-conducting state in the reset period.

Next, the photocurrent integration period (T_{INT}) begins when the reset signal returns to the low level V_{RST.L} at time t₁, and the voltage drop V_{FT} occurs in the potential V_{INT} of the connection point INT at this time t₁ due to reset feed-through. In other words, the potential V_{INT} of the connection point INT at time t₁ is expressed by Expression (7) below.

V_{INT}=V_{RST.H}−V_{F}−V_{FT} (7)

Note that the voltage drop V_{FT} due to reset feed-through in the photosensor of the present embodiment has a smaller value than that in conventional technology, as described above using Expressions (4) and (5).

In the integration period T_{INT}, a photocurrent that is proportionate to the amount of incident light received by the photodiode D1 flows out of the capacitor C1 to discharge the capacitor C1. Accordingly, the potential V_{INT} of the connection point INT when the integration period T_{INT} ends is expressed by Expression (8) below.

V_{INT}=V_{RST.H}−V_{FT}−V_{F}−I_{PHOTO}·t_{INT}/C_{TOTAL} (8)

In Expression (8), I_{PHOTO} is the photocurrent of the photodiode D1, and t_{INT} is the length of the integration period. In the integration period as well, V_{INT} is lower than the threshold voltage of the thin-film transistor M2, and therefore the thin-film transistor M2 is in the non-conducting state.

When the integration period ends, the readout signal rises at time t2 as shown in FIG. 7, and thus the readout period begins. Here, the injection of charge into the capacitor C1 occurs. As a result, the potential V_{INT} of the connection point INT is expressed by Expression (9) below.

V_{INT}=V_{RST.H}−V_{FT}−V_{F}−I_{PHOTO}−t_{INT}/C_{TOTAL}+ΔV_{RWS}·C_{INT}/C_{T} (9)

ΔV_{RWS} is the pulse height of the readout signal (V_{RWS.H}−V_{RWS.L}). Accordingly, since the potential V_{INT} of the connection point INT is higher than the threshold voltage of the thin-film transistor M2, the thin-film transistor M2 enters a conductive state and functions as a source follower amplifier along with the bias thin-film transistor M3 provided at the end of the wiring OUT in each column. In other words, the output signal voltage from the output wiring SOUT from the drain of the thin-film transistor M3 corresponds to the integral value of the photocurrent of the photodiode D1 in the integration period.

As described above, in the present embodiment, operations are performed cyclically in which one cycle involves initialization by a reset pulse, integration of the photocurrent in the integration period, and readout of sensor output in the readout period.

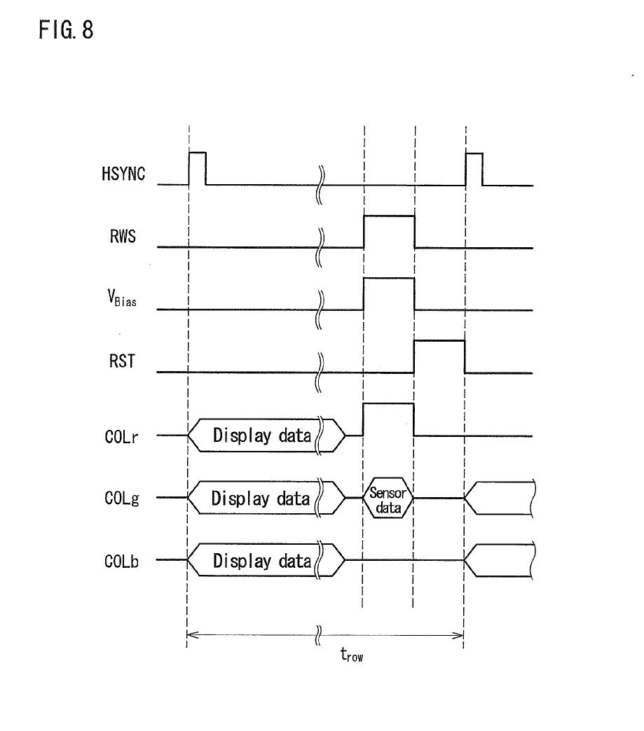

Note that in the present embodiment, as previously mentioned, the source lines COLr and COLg are also used as the photosensor lines VDD and OUT, and therefore it is necessary to distinguish between times when image data signals for display are input via the source lines COLr, COLg, and COLb, and times when sensor output is read out, as shown in FIG. 8. In the example in FIG. 8, after the input of image data signals for display in a horizontal scan period has ended, the reading out of the sensor output is performed using a horizontal blanking period or the like. Note that HSYNC in FIG. 8 indicates a horizontal synchronization signal.

As shown in FIG. 1, the sensor column driver 4 includes a sensor pixel readout circuit 41, a sensor column amplifier 42, and a sensor column scan circuit 43. The sensor pixel readout circuit 41 is connected to the output wiring SOUT (see FIG. 2) that outputs the sensor output V_{SOUT} from the pixel region 1. In FIG. 1, the sensor output that is output by output wiring SOUTj (j=1 to N) is designated by V_{SOUTj}. The sensor pixel readout circuit 41 outputs peak hold voltages V_{Sj} of the sensor output V_{SOUTj} to the sensor column amplifier 42. The sensor column amplifier 42 includes N column amplifiers that correspond to the photosensors in the N columns in the pixel region 1, and the column amplifiers amplify the corresponding peak hold voltages CSⱼ (j=1 to N), and output the resulting peak hold voltages to the buffer amplifier 6 as V_{COUT}. The sensor column scan circuit 43 outputs column select signals CSⱼ (j=1 to N) to the sensor column amplifier 42 in order to successively connect the column amplifiers of the sensor column amplifier 42 to the output bound for the buffer amplifier 6.

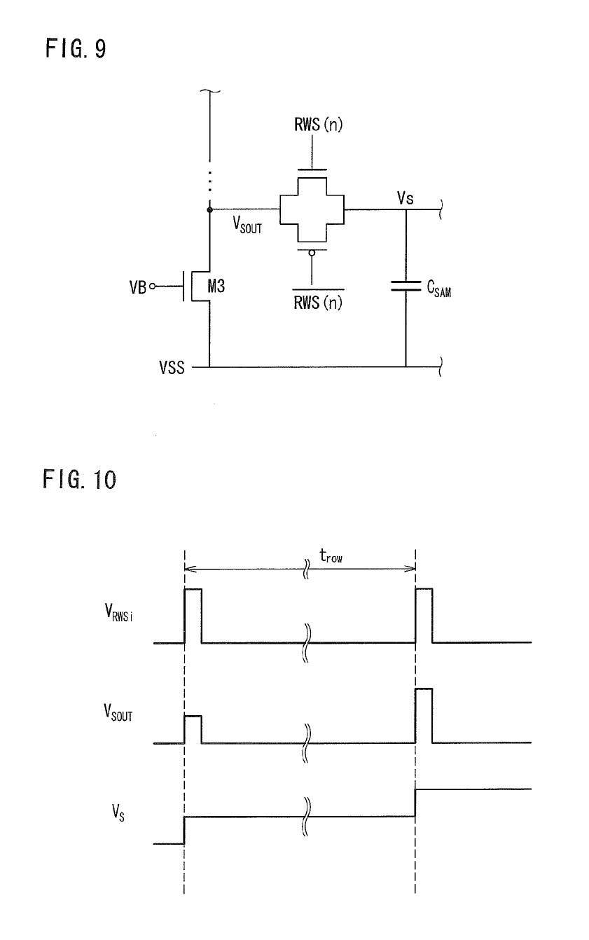

The following describes operations of the sensor column driver 4 and the buffer amplifier 6 that are performed after the sensor output V_{SOUT} has been read out from the pixel region 1, with reference to FIGS. 9 and 10. FIG. 9 is a circuit diagram showing an internal configuration of the sensor pixel readout circuit 41. FIG. 10 is a waveform diagram showing a relationship between a readout signal, sensor output, and output of the sensor pixel readout circuit. As previously described, when the readout signal has risen to the high level V_{RWS.H}, the thin-film transistor M2 becomes conductive, and therefore a source follower amplifier is formed by the thin-film transistors M2 and M3, and the sensor output V_{SOUT} is accumulated in a sample capacitor C_{SAM} of the sensor pixel readout circuit 41. Accordingly, even after the readout signal has fallen to the low level V_{RWS.L}, in the selection period of that row (t_{row}), the output voltage V_{S} from the sensor pixel readout circuit 41 to the sensor column amplifier 42 is kept at the same level as the peak value of the sensor output V_{SOUT}, as shown in FIG. 10.

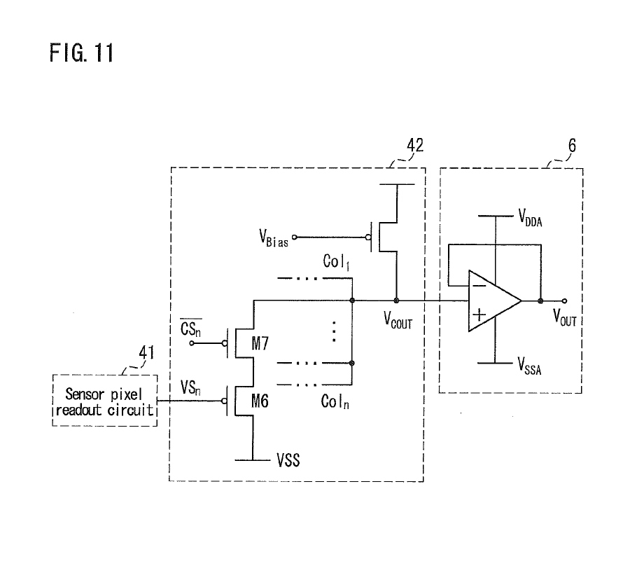

Next is a description of operations of the sensor column amplifier 42 with reference to FIG. 11. As shown in FIG. 11, the output voltages V_{Sj} (j=1 to N) of the columns are input from the sensor pixel readout circuit 41 to the N column amplifiers of the sensor column amplifier 42. As shown in FIG. 11, each column amplifier is composed of thin-film transistors M6 and M7. The column select signals CS; generated by the sensor column scan circuit 43 successively become on for each of the N columns in the select period of one row (t_{row}), and therefore the thin-film transistor M6 of only one of the N column amplifiers in the sensor column amplifier 42 is switched on, and only one of the output voltages V_{Sj} (j=1 to N) of the columns is output as the output V_{COUT} from the sensor column amplifier 42 via that thin-film transistor M6. The buffer amplifier 6 then amplifies the V_{COUT} that has been output from the sensor column amplifier 42, and outputs the resulting amplified V_{COUT} to the signal processing circuit 8 as panel output (a photosensor signal) Vₒᵤₜ.

Note that although the sensor column scan circuit 43 may scan the photosensor columns one column at a time as described above, there is no limitation to this, and a configuration is possible in which the photosensor columns are interlace-scanned. Also, the sensor column scan circuit 43 may be formed as a multi-phase drive scan circuit that has, for example, four phases.

According to the above configuration, the display device of the present embodiment obtains panel output V_{OUT} that is in accordance with the amount of light received by the photodiode D1 formed in each pixel in the pixel region 1. The panel output V_{OUT} is sent to the signal processing circuit 8, subjected to A/D conversion, and then accumulated in a memory (not shown) as panel output data. Specifically, the same number of panel output data pieces as the number of pixels (number of photosensors) in the pixel region 1 are accumulated in this memory. With use of the panel output data accumulated in the memory, the signal processing circuit 8 performs various types of signal processing such as image pickup and the detection of a touch area. Note that although the same number of panel output data pieces as the number of pixels (number of photosensors) in the pixel region 1 are accumulated in the memory of the signal processing circuit 8 in the present embodiment, due to constraints such as memory capacity, there is no need to necessarily accumulate the same number of panel output data pieces as the number of pixels.

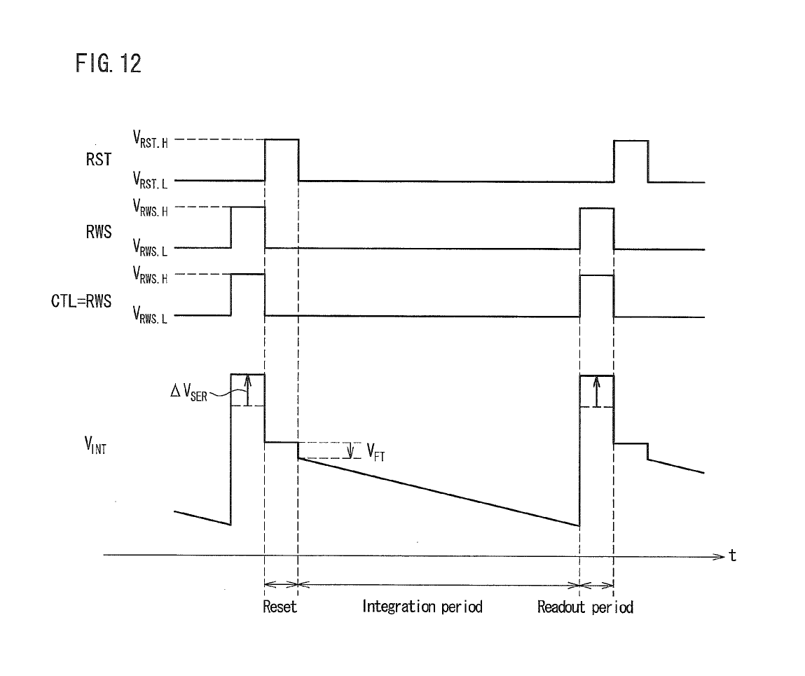

Note that in the photosensor of the present embodiment, the same signal as the readout signal may be applied to the electrode CTL, as shown in FIG. 12. In this case, as shown in FIG. 12, in the readout period, due to the voltage V_{RWS.H} being applied to the electrode CTL, the potential V_{INT} of the storage node is influenced by not only an upthrust via the capacitor C1, but also an upthrust via the series capacitors C_{SER}, Cₐ, Cᵢ, and C_{c} (ΔV_{SER} shown in FIG. 12). This has an effect of improving the upthrust efficiency of the potential V_{INT} of the storage node.

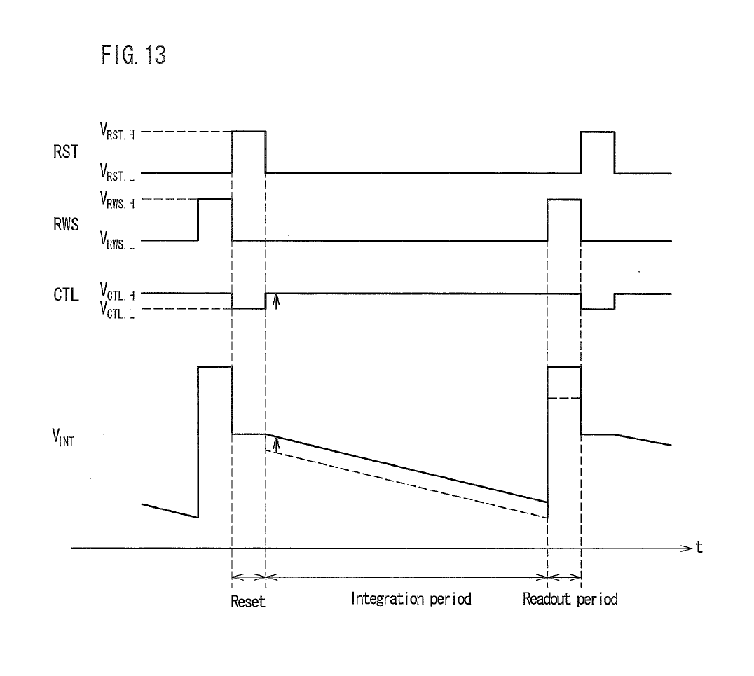

Also, in the photosensor of the present embodiment, a pulse signal that counteracts reset feed-through may be applied to the electrode CTL, as shown in FIG. 13. In this case, as shown in FIG. 13, (1) the potential of the signal applied to the electrode CTL changes from V_{CTL.H} to V_{CTL.L}, when the reset period starts, and (2) the potential of the signal applied to the electrode CTL changes from V_{CTL.L} to V_{CTL.H} at the same time as the potential of the reset signal switches from V_{RST.H} to V_{RST.L} when the reset period ends. This enables counteracting reset feed-through that occurs when the potential of the reset signal switches from V_{RST.H} to V_{RST.L} when the reset period ends, thus enabling preventing a voltage drop due to reset feed-through at the beginning of the integration period as shown in FIG. 13. In FIG. 13, the broken line waveform indicates transitions in the potential V_{INT} of the storage node in the case where reset feed-through occurs, and the solid line waveform indicates transitions in the potential V_{INT} of the storage node in the case where reset feed-through has been counteracted. Note that it is sufficient that the potential difference between the low potential V_{CTL.L} and high potential V_{CTL.H} of the pulse applied to the electrode CTL is determined appropriately according to, for example, the magnitude of the voltage drop V_{FT} due to reset feed-through.

As described above, the present embodiment enables reducing or eliminating the voltage drop V_{FT} due to reset feed-through when the integration period starts, thus having an effect of enabling providing a photosensor with a wide dynamic range.

### Embodiment 2

Below is a description of Embodiment 2 of the present invention.

Constituent elements having the same functions as constituent elements described in Embodiment 1 are given the same reference numerals as those in Embodiment 1, and detailed descriptions thereof will be omitted.

In Embodiment 1, the electrode CTL is formed as wiring using the same material as the gate metal. Embodiment 2 differs from Embodiment 1 in that the electrode CTL is connected to a shield electrode provided on the photosensor. Note that the shield electrode is a transparent electrode that is provided so as to cover the entirety of the photosensor in order to prevent interference with the photosensor from external circuitry, and that always receives an application of a predetermined voltage while the photosensor is operating. The shield electrode can be formed from ITO, for example.

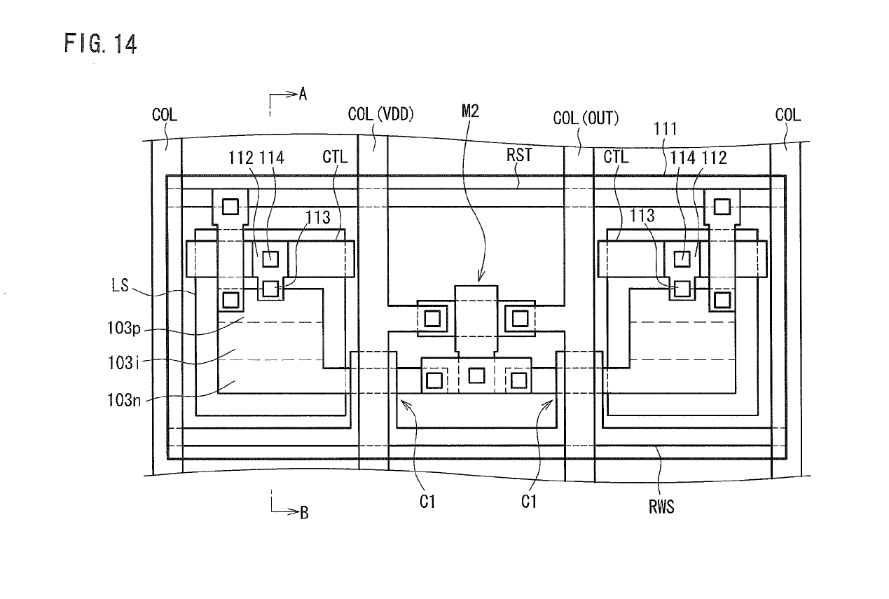

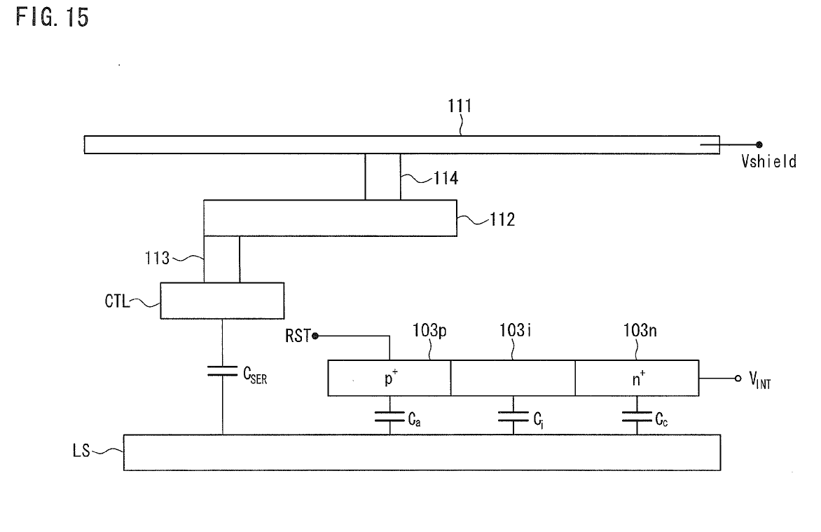

FIG. 14 is a plan view showing an example of the planar structure of the photosensor according to Embodiment 2. FIG. 15 is a schematic diagram showing electrical connection relationships between members in a cross-section taken along line A-B shown in FIG. 14.

As shown in FIG. 14, the photosensor of the present embodiment includes a shield electrode 111 formed from a transparent metal such as ITO so as to cover the entirety of the photosensor. The shield electrode 111 is electrically connected to the electrode CTL via a contact 114, wiring 112, and a contact 113. The contact 114 is formed from the same material as the shield electrode 111. The wiring 112 and the contact 113 are formed from the same material as the source metal.

Since a constant voltage is always supplied to the shield electrode 111, the potential of the electrode CTL opposing the light shielding film LS is also kept at a constant voltage likewise to the shield electrode 111. As described using Expression (4), Expression (5), and FIG. 5 in Embodiment 1, this enables reducing the voltage drop V_{FT} due to reset feed-through when the integration period starts.

Also, in the configuration of Embodiment 2, a pulse signal that counteracts reset feed-through may be applied to the electrode CTL via the shield electrode 111, as was described with reference to FIG. 13 in Embodiment 1. This has an effect of enabling completely eliminating the voltage drop V_{FT} due to reset feed-through as shown in FIG. 13.

As described above, according to the configuration of Embodiment 2, the electrode CTL opposing the light shielding film LS is connected to the shield electrode 111, and a constant voltage or a pulse signal that counteracts reset feed-through is supplied to the electrode CTL via the shield electrode 111. This has an effect of enabling providing a photosensor with a wide dynamic range.

### Embodiment 3

Below is a description of Embodiment 3 of the present invention. Constituent elements having the same functions as constituent elements described in the above embodiments are given the same reference numerals as those in the above embodiments, and detailed descriptions thereof will be omitted.

Although the electrode CTL that forms the capacitor C_{SER} with the light shielding film LS is formed separately from the wiring RST and RWS in Embodiments 1 and 2, the electrode CTL is formed of the wiring RWS in the photosensor of the present embodiment.

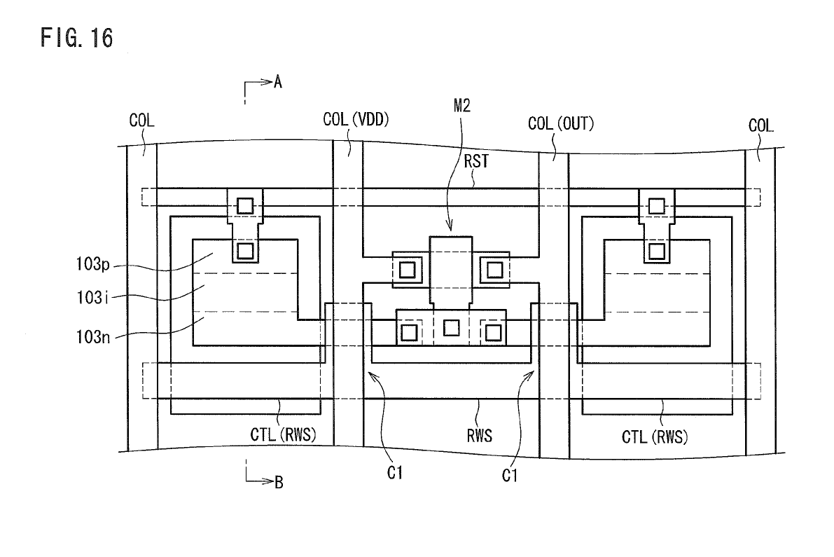

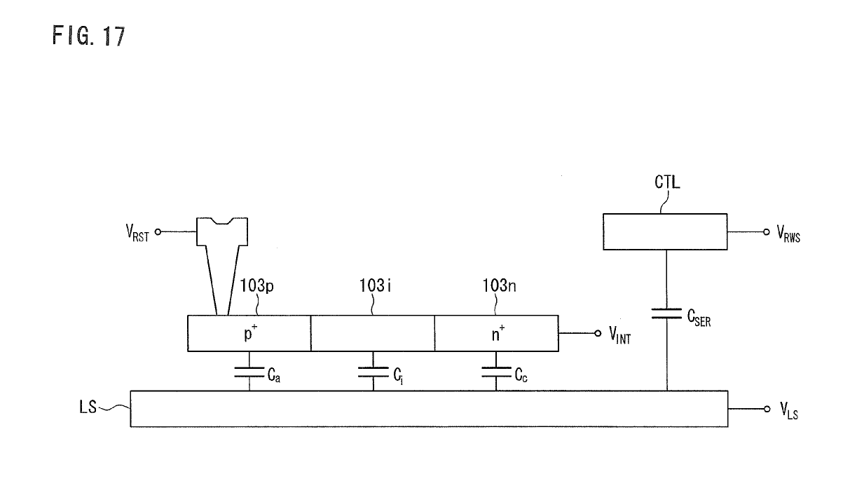

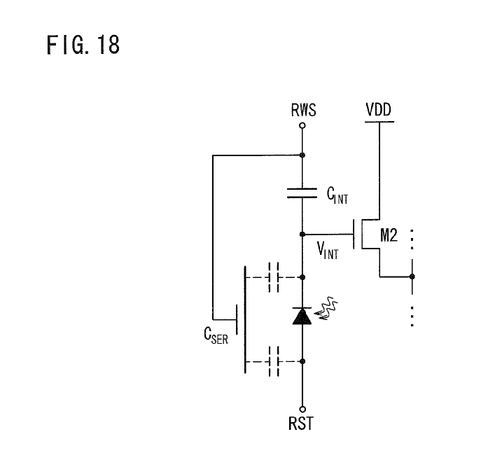

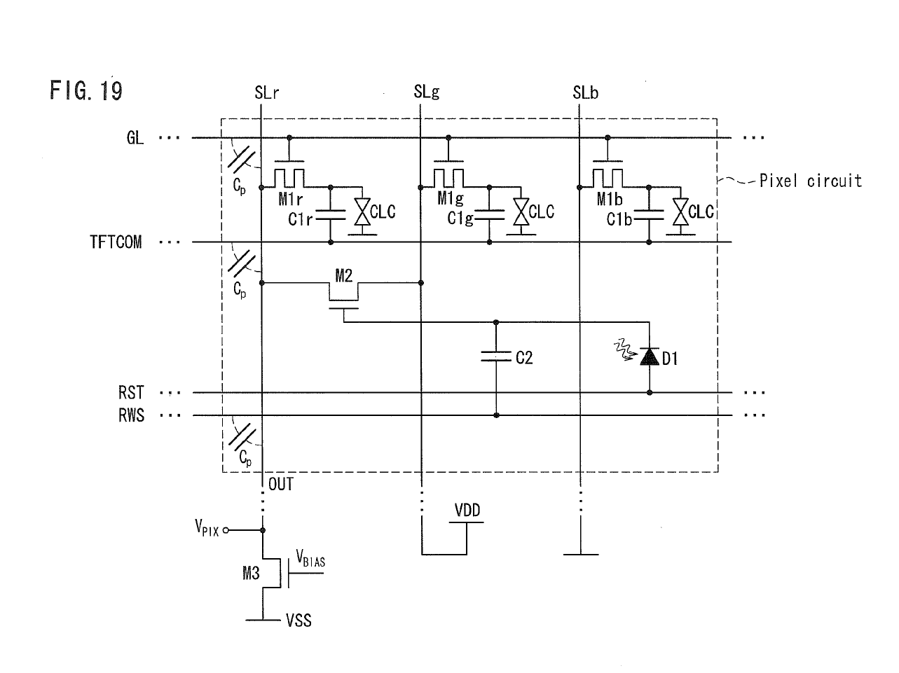

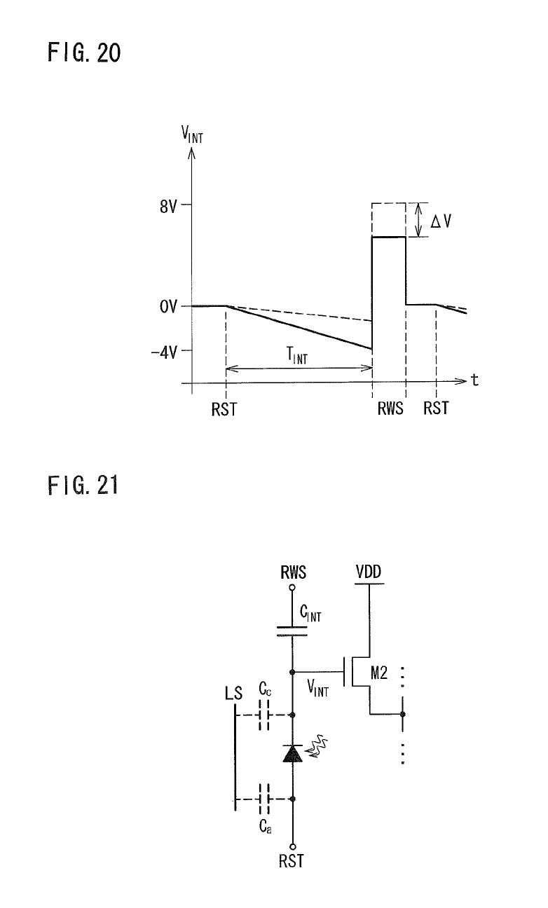

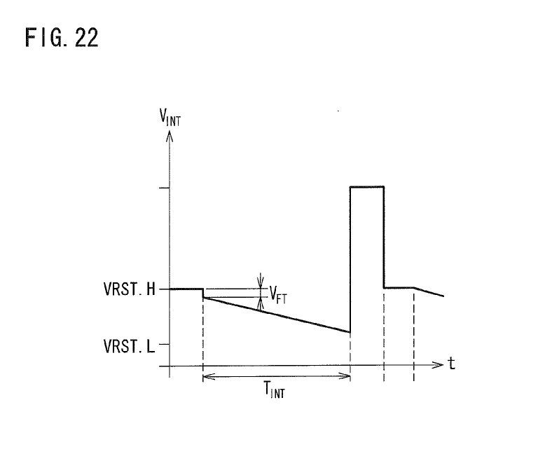

FIG. 16 is a plan view showing an example of the planar structure of the photosensor according to Embodiment 3. FIG. 17 is a schematic diagram showing electrical connection relationships between members in a cross-section taken along line A-B shown in FIG. 16. FIG. 18 is an equivalent circuit diagram of the photosensor according to the present embodiment.

As shown in FIG. 16, in the photosensor of Embodiment 3, the wiring RWS is provided so as to overlap the light shielding film LS. Accordingly, the capacitor C_{SER} is formed between the wiring RWS and the light shielding film LS as shown in FIG. 17. Also, as shown in FIGS. 17 and 18, the potential of the electrode CTL is the same potential as that of the wiring RWS. The voltage applied to the electrode CTL therefore conforms to that shown in FIG. 12 in Embodiment 1. Accordingly, as described in Embodiment 1, in the readout period, due to the voltage V_{RWS.H} being applied to the electrode CTL, the potential V_{INT} of the storage node is influenced by not only an upthrust via the capacitor C1, but also an upthrust via the series capacitors C_{SER}, Cₐ, Cᵢ, and C_{c} (ΔV_{SER} shown in FIG. 12). This has an effect of improving the upthrust efficiency of the potential V_{INT} of the storage node.

Although the present invention has been described based on Embodiments 1 to 3, the present invention is not limited to the above-described embodiments only, and it is possible to make various changes within the scope of the invention.

For example, an example of a configuration in which the lines VDD and OUT that the photosensor is connected to are also used as the source line COL is described in the above embodiments. This configuration has the advantage that the pixel aperture ratio is high. However, since the photosensor wiring is also used as the source line COL in this configuration, it is impossible to read out the sensor circuit output data while the video signal for pixel display is being applied to the source line COL. For this reason, it is necessary to apply the readout signal for the sensor circuit output data in the blanking period as shown in FIG. 8. In view of this, a configuration is possible in which the photosensor lines VDD and OUT are provided separately from the source line COL. This configuration has a lower pixel aperture ratio, but enables the photosensor wiring to be driven independently from the source line COL, and therefore has the advantage of enabling the sensor circuit output data to be read out regardless of the pixel display timing.

Also, although the example in which the sensor circuit includes the capacitor C1 as the storage capacitor is given in the above-described embodiments, even if a circuit element corresponding to the storage capacitor is not provided in the sensor circuit, it is possible for the parasitic capacitance that is formed at the storage node to be used as the storage capacitor. The capacitor C1 is therefore not essential.

Note that as an alternative to the above description, a configuration is possible in which transistors M3 to M7 provided in an IC chip, for example, are used instead of the thin-film transistors M3 to M7 formed on the active matrix substrate.

### INDUSTRIAL APPLICABILITY

The present invention is industrially applicable as a display device having a photosensor in a pixel region of an active matrix substrate.

### REFERENCE SIGNS

1 pixel region
2 display gate driver
3 display source driver
4 sensor column driver
41 sensor pixel readout circuit
42 sensor column amplifier
43 sensor column scan circuit
5 sensor row driver
6 buffer amplifier
7 FPC connector
8 signal processing circuit
9 FPC
100 active matrix substrate

1. A display device comprising a photosensor in a pixel region of an active matrix substrate,
the photosensor comprising:
a photodetection element that receives incident light;
a storage node that is connected to the photodetection element, the potential of the storage node changing in accordance with an output current from the photodetection element;
reset signal wiring that supplies a reset signal to the photosensor;
readout signal wiring that supplies a readout signal to the photosensor;
a sensor switching element for reading out the potential of the storage node to output wiring as sensor circuit output, the potential of the storage node having changed in accordance with the amount of light received by the photodetection element in a sensing period, the sensing period being from when the reset signal is supplied until when the readout signal is supplied;
a light shielding film provided on a side of the photodetection element that is opposite to a light receiving face thereof; and
an electrode provided opposing the light shielding film so as to form a capacitor in series with a parasitic capacitance between the light shielding film and the photodetection element,
wherein a signal for reducing a voltage drop in the storage node that accompanies a change in the potential of the reset signal is applied to the electrode when the sensing period starts.

2. The display device according to claim 1, wherein the electrode is metal wiring provided in parallel with the reset signal wiring and the readout signal wiring.

3. The display device according to claim 2, wherein the signal applied to the electrode is the same as the readout signal.

4. The display device according to claim 2, wherein the signal applied to the electrode is a signal that counteracts the voltage drop in the storage node that accompanies a change in the potential of the reset signal.

5. The display device according to claim 1, further comprising:
a shield electrode that covers the photosensor,
wherein the electrode is electrically connected to the shield electrode.

6. The display device according to claim 5, wherein the signal applied to the electrode is a constant potential signal.

7. The display device according to claim 5, wherein the signal applied to the electrode is a signal that counteracts the voltage drop in the storage node that accompanies a change in the potential of the reset signal.

8. The display device according to claim 1, wherein the electrode is a portion of the readout signal wiring.

9. The display device according to claim 1, further comprising:
a common substrate opposing the active matrix substrate; and
liquid crystal sandwiched between the active matrix substrate and the common substrate.
